(19) United States
(12) Patent Application Publication
(10) Pub. No.: US 2006/0268848 A1
(43) Pub. Date: Nov. 30, 2006

(54) Connection type handover of voice over internet protocol call based low-quality detection

(75) Inventors: Anders Larsson, Stockholm (SE); Martin Backstrom, Danderyd (SE)

Correspondence Address: NIXON & VANDERHYE, PC, 901 NORTH GLEBE ROAD, 11TH FLOOR, ARLINGTON, VA, 22203, US

(73) Assignee: Telefonaktiebolaget LM Ericsson (publ), Stockholm (SE)

(21) Appl. No.: 11/298,938

(22) Filed: Dec. 12, 2005

Related U.S. Application Data
(60) Provisional application No. 60/684,214, filed on May 25, 2005.

(51) Int. Cl. H04L 12/66

(52) U.S. Cl. 370/356

(57) ABSTRACT

A telecommunications network comprises a base transceiver station node (28) and a packet control unit (PCU) 25. The base transceiver station node (28) serves, e.g., for providing radio transmission resources to a cell (C) for radio frequency communications. The packet control unit (PCU) 25 serves for allocating the radio transmission resources to respective voice over internet protocol (VoIP) calls handled as packet switched connections. In addition, for at least one VoIP call, the packet control unit (PCU) 25 is arranged for determining whether the at least one VoIP call should be changed from one connection type to another connection type, e.g., from a packet switched connection to a circuit switched connection. In an illustrated, example, non-limiting embodiment, the packet control unit (PCU) 25 determines whether the at least one VoIP call should be changed from a packet switched connection to a circuit switched connection by monitoring, in the telecommunications network, speech quality of packets comprising the at least one VoIP call. In accordance with the monitoring, the base station controller node is arranged for selectively requesting that the at least one VoIP call be changed from a packet switched connection to a circuit switched connection.

This application claims the benefit and priority of U.S. Provisional Patent Application 60/684,214, filed May 25, 2005, the entire contents of which is incorporated by reference in its entirety.

This application is related to simultaneously-filed U.S. patent application Ser. No. ______ (attorney docket 2380-921), entitled “CONNECTION TYPE HANDOVER OF VOICE OVER INTERNET PROTOCOL CALL BASED ON RESOURCE TYPE”, which is also incorporated by reference in its entirety

This application is related to U.S. patent application Ser. No. ______ (attorney docket 2380-931), filed Nov. 29, 2005, entitled “SCHDULING RADIO RESOURCES FOR SYMMETRIC SERVICE DATA CONNECTIONS”, which is also incorporated by reference in its entirety.

This application is also related to the following related US Provisional patent applications, all of which are also incorporated by reference in their entirety:

U.S. Provisional Patent Application 60/684,216 entitled “GSM VoIP PS-to-CS Handover at Allocation to Frequency-Hopping Edge TRX,” filed on May 25, 2005;

U.S. Provisional Patent Application 60/684,215 entitled “Local Switching AGC,” filed on May 25, 2005;

U.S. Provisional Patent Application 60/684,232 entitled “Method to Improve VoIP Media Flow Quality by Adapting Speech Encoder and LQC Based on EDGE MCS;

U.S. Provisional Patent Application 60/684,188, filed May 25, 2005;

U.S. Provisional Patent Application 60/684,233 entitled “Authenticated Identification of VoIP Flow in BSS,” filed on May 25, 2005.

### BACKGROUND

1. Technical Field

The present invention pertains to telecommunications, and particularly to Voice over Internet Protocol (VoIP).

2. Related Art and Other Considerations

Voice over Internet Protocol (VoIP) in the mobile world means using a packet switched (PS) service for transport of Internet Protocol (IP) packets (which contain, e.g., Adaptive Mutli-Rate codec (AMR) speech frames) for normal mobile phone calls. In circuit-switched networks, network resources are static from the sender to receiver before the start of the transfer, thus creating a “circuit”. The resources remain is dedicated to the circuit during the entire transfer and the entire message follows the same path. In packet-switched networks, the message is broken into packets, each of which can take a different route to the destination where the packets are recompiled into the original message.

The packet switched (PS) service utilized for VoIP can be, for example, GPRS (General Packet Radio Service), EDGE (Enhanced Data Rates for Global Evolution), or WCDMA (Wideband Code Division Multiple Access). Each of these example services happen to be built upon the Global System for Mobile communications (GSM), a second generation (“2G”) digital radio access technology originally developed for Europe. GSM was enhanced in 2.5G to include technologies such as GPRS. The third generation (3G) comprises mobile telephone technologies covered by the International Telecommunications Union (ITU) IMT-2000 family. The Third Generation Partnership Project (3GPP) is a group of international standards bodies, operators, and vendors working toward standardizing WCDMA-based members of the IMT-2000.

EDGE (or Enhanced Data Rates for Global Evolution) is a 3G technology that delivers broadband-like data speeds to mobile devices. EDGE allows consumers to connect to the Internet and send and receive data, including digital images, web pages and photographs, three times faster than possible with an ordinary GSM/GPRS network. EDGE enables GSM operators to offer higher-speed mobile-data access, serve more mobile-data customers, and free up GSM network capacity to accommodate additional voice traffic.

EDGE provides three times the data capacity of GPRS. Using EDGE, operators can handle three times more subscribers than GPRS; triple their data rate per subscriber, or add extra capacity to their voice communications. EDGE uses the same TDMA (Time Division Multiple Access) frame structure, logic channel and 200 kHz carrier bandwidth as GSM networks, which allows existing cell plans to remain intact.

In EDGE technology, a base transceiver station (BTS) communicates with a mobile station (e.g., a cell phone, mobile terminal or the like, including computers such as laptops with mobile termination). The base transceiver station (BTS) typically has plural transceivers (TRX), with each transceiver having plural timeslots. Some of the transceivers (TRX) which may be capable of “hopping”, e.g., frequency hopping. Frequency hopping is a process in which the data signal is modulated with a narrowband carrier signal that “hops” in a random but predictable sequence from frequency to frequency as a function of time over a wide band of frequencies.

A number of situations can result in packet switched (PS) transfer speeds being below what is required for good VoIP quality. One such situation is a drop or decrease in carrier to interference ratio (C/I) to such a low level that additional timeslots (if added) could not compensate for a high bit error rate. Another situation occurs when there is insufficiently allocated capacity to PS data for a specific cell at a specific moment, resulting in “jitter” and too low transfer speed. A third situation is a cell change to an old transceiver (TRX) which is not EDGE-enabled, resulting in a change down to GPRS. A fourth situation is based on limitations in the data network or IP Multimedia Subsystem (IMS) network. A fifth situation occurs when transmission to the RBS site is made with a statistical (packet based) method, resulting in a certain calculated risk of blocking on the actual transmission.

In all these situations, while the VoIP call can survive, speech quality may not be as good as desired. Currently, the IMS system (downlink) and the VoIP client in the phone (uplink) will just keep sending speech data, despite the degree of speech quality, even if the resulting speech quality for the listening party is poor.

### SUMMARY

A telecommunications network comprises a base transceiver station node and a packet control unit. The base transceiver station node serves, e.g., for providing radio transmission resources to a cell for radio frequency communications. The packet control unit serves for allocating the radio transmission resources to respective voice over internet protocol (VoIP) calls handled as packet switched connections. In addition, for at least one VoIP call, the packet control unit is arranged for determining whether the at least one VoIP call should be changed from one connection type to another connection type, e.g., from a packet switched connection to a circuit switched connection.

In an illustrated, example, non-limiting embodiment, the packet control unit determines whether the at least one VoIP call should be changed from a packet switched connection to a circuit switched connection by monitoring speech quality. In accordance with the monitoring, the packet control unit is arranged for requesting that the at least one VoIP call be changed from a packet switched connection to a circuit switched connection.

In one mode of operation, for monitoring speech quality of the VoIP packet flow for the VoIP call, the packet control unit monitors, in the telecommunications network, a transfer speed of packets comprising the VoIP call. In an example implementation, the packet control unit comprises a buffer and is arranged for monitoring a transfer speed in the buffer of the packets comprising the at least one VoIP. For example, the packet control unit can monitor the transfer speed by determining when a utilized amount of the buffer exceeds a predetermined threshold. Alternatively, the packet control unit can monitor the transfer speed by determining when a variation of a utilized amount of the buffer exceeds a predetermined threshold (e.g., buffer fullness).

In an example implementation, the buffer which is monitored by the packet control unit can be a logical link control layer (LLC) buffer, and the voice over internet protocol (VoIP) calls can be EDGE VoIP packet flows.

In another mode of operation, for monitoring speech quality of the VoIP packet flow for the VoIP call, the packet control unit monitors lost or damaged frames carrying the VoIP speech. If the number of lost of damaged frames exceeds a predetermined limit, the packet control unit requests that the at least one VoIP call be changed from a packet switched connection to a circuit switched connection.

The packet control unit can be located either entirely or partially at any suitable network node, such as at a base station control (BSC) node, the base station node, and a GPRS Support node (GSN).

Requesting that the at least one VoIP call be changed from a packet switched connection to a circuit switched connection can comprises requesting a mobile station participating in the call to perform a packet-switch to circuit-switch handover and thereby reattach the call as a circuit switch call.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a simplified function block diagram of a portion of a generic network including portions of a mobile station (MS), portions of a base transceiver station (BTS), and portions of a packet control unit (PCU), the packet control unit (PCU) including a speech quality monitor.

FIG. 1A is a simplified function block diagram showing a variation of the network of FIG. 1 wherein the packet control unit (PCU) is located at a base station control (BSC) node.

FIG. 1B is a simplified function block diagram showing a variation of the network of FIG. 1 wherein the packet control unit (PCU) is located at a base transceiver station (BTS).

FIG. 1C is a simplified function block diagram showing a variation of the network of FIG. 1 wherein the packet control unit (PCU) is located at a GPRS Support node (GSN).

FIG. 2A is a simplified function block diagram of a generic network such as that of FIG. 1 and wherein the speech quality monitor of the packet control unit (PCU) is a transfer speed monitor.

FIG. 2B is a flowchart showing basic, example, representative, non-limiting steps or actions performed by the packet control unit (PCU) of FIG. 2A in a first example mode of operation.

FIG. 3A is a simplified function block diagram of a generic network such as that of FIG. 1 and wherein the speech quality monitor of the packet control unit (PCU) is a frame monitor.

FIG. 3B is a flowchart showing basic, example, representative, non-limiting steps or actions performed by the packet control unit (PCU) of FIG. 3A in a second example mode of operation.

FIG. 4 is diagrammatic view of example telecommunications system in which the present technology may be advantageously employed.

FIG. 5 is a protocol diagram of an EDGE (Enhanced Data Rates for Global Evolution) system.

FIG. 6A and FIG. 6B are graphs respectively reflecting good and bad cases of buffer fullness in accordance with the first mode of operation.

FIG. 7A and FIG. 7B are graphs respectively reflecting good and bad cases of packet throughput in accordance with the first mode of operation.

### DETAILED DESCRIPTION OF THE DRAWINGS

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry embodying the principles of the technology. Similarly, it will be appreciated that any flow charts, state transition diagrams, pseudo code, and the like represent various processes which may be substantially represented in computer readable medium and so executed by a computer or processor, whether or not such computer or processor is explicitly shown.

The functions of the various elements including functional blocks labeled as “processors” or “controllers” may be provided through the use of dedicated hardware as well as hardware capable of executing software in association with appropriate software. When provided by a processor, the functions may be provided by a single dedicated processor, by a single shared processor, or by a plurality of individual processors, some of which may be shared or distributed. Moreover, explicit use of the term “processor” or “controller” should not be construed to refer exclusively to hardware capable of executing software, and may include, without limitation, digital signal processor (DSP) hardware, read only memory (ROM) for storing software, random access memory (RAM), and non-volatile storage.

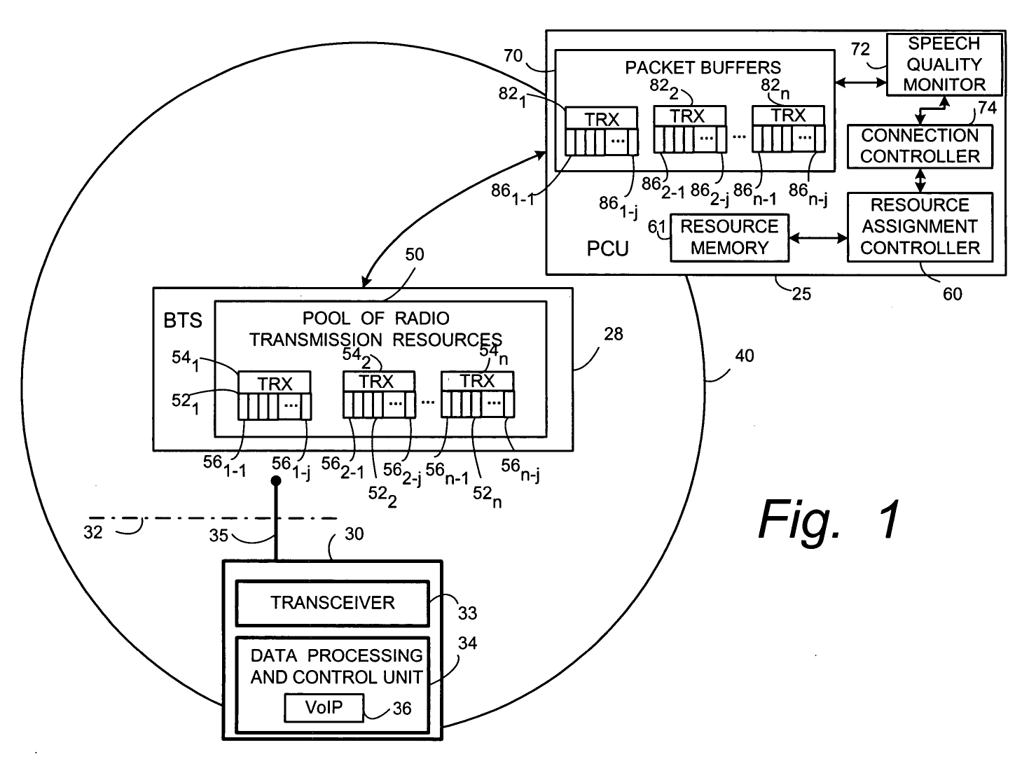

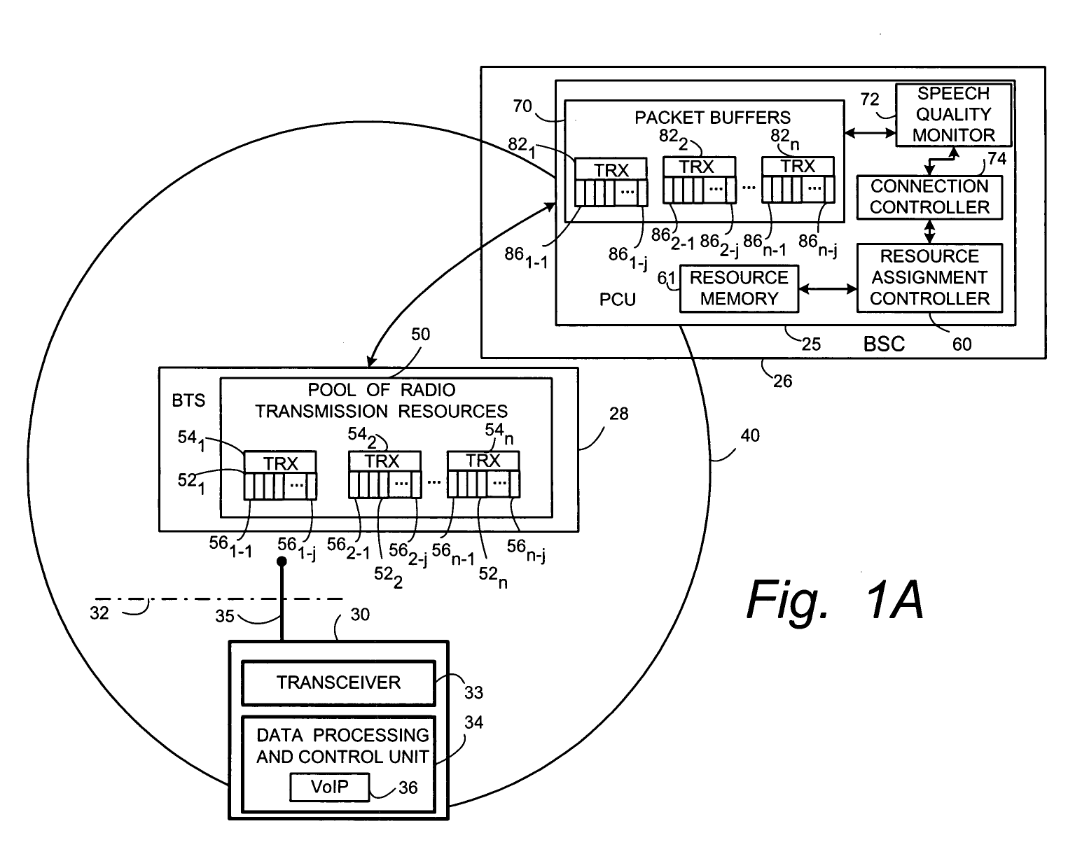

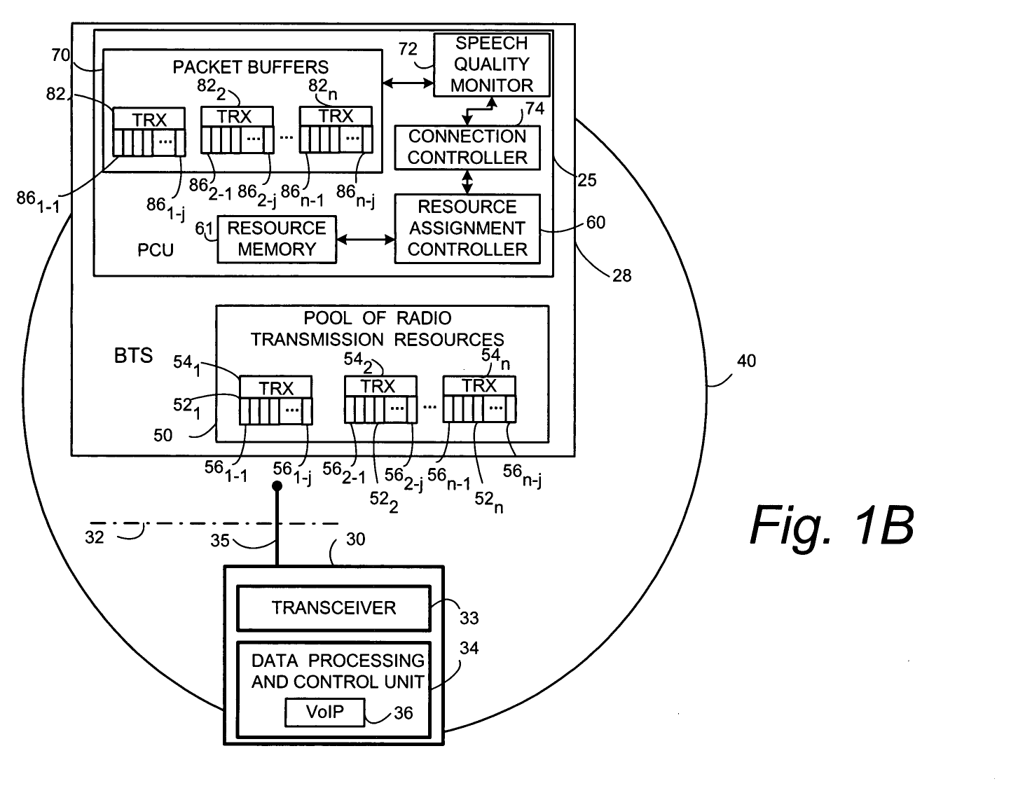

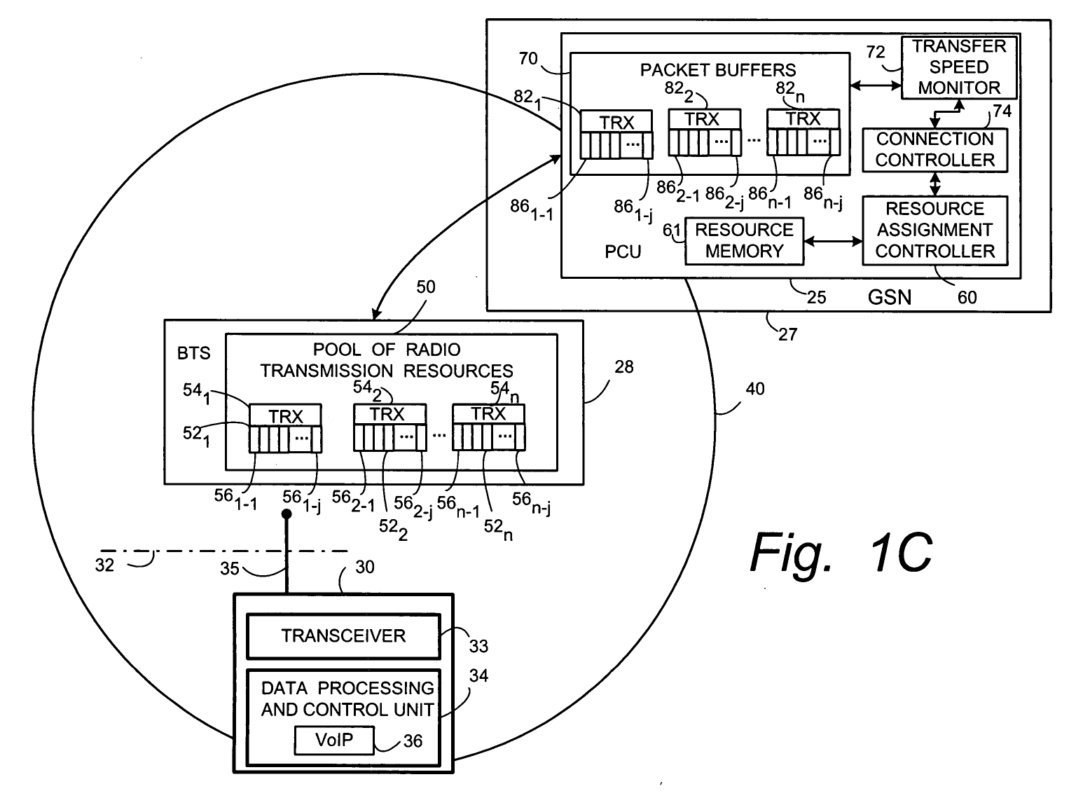

FIG. 1 shows a portion of a generic radio access network including portions of a packet control unit (PCU) 25 and portions of a base transceiver station (BTS) 28, as well as a mobile station (MS) 30 in radio frequency communication over an air interface 32 with base transceiver station (BTS) 28. The mobile station (MS) 30 includes a transceiver 33 and a data processing and control unit 34. Included in data processing and control unit 34 are functionalities for providing a voice over Internet Protocol (VoIP) capability, e.g., VoIP application 36. The person skilled in the art will recognize that mobile station (MS) 30 and data processing and control unit 34 in particular typically includes numerous other functionalities and applications, as well as unillustrated input/output devices such as a screen, keypad, and the like.

The base transceiver station (BTS) 28 serves one or more cells, such as cell 40. In serving cell 40, base transceiver station (BTS) 28 provides a pool 50 of radio transmission resources. As conceptualized in an example embodiment of FIG. 1, pool 50 comprises plural sets 52₁-52ₙ of radio transmission resources for communicating with mobile stations in cell 40.

In the illustrated, example, non-limiting implementation of FIG. 1, at least one set of radio transmission resources of the cell is a non-hopping set of radio transmission resources. For example, in the implementation of FIG. 1 set 52, is a non-hopping set of radio transmission resources. Other sets of radio transmission resources of the cell, such as sets 52₂-52ₙ are hopping sets of radio transmission resources. In the example implementation of the FIG. 1 embodiment, the non-hopping set 52₁ of radio transmission resources comprise radio transmission resources provided by a non-hopping transceiver 54₁. The radio transmission resources provided by the non-hopping transceiver 54₁ comprise timeslots 56₁₋₁ through 56₁₋ⱼ on a frequency upon which the non-hopping transceiver 54₁ operates. Similarly, the hopping sets 52₂-52ₙ of radio transmission resources comprise radio transmission resources provided by respective hopping transceivers 54₂-52ₙ and the radio transmission resources provided by the hopping transceivers comprise timeslots on respective frequencies upon which the hopping transceivers operate. For example, the radio transmission resources provided by hopping transceiver 54₂ comprise timeslots 56₂₋₁ through 56₂₋ⱼ; the radio transmission resources provided by hopping transceiver 54₃ comprise timeslots 56₃₋₁ through 56₃₋ⱼ; and so forth. It should be understood that the technology described herein does not require use of a certain number (or, in fact, any) hopping sets of radio transmission resources.

Optionally in the foregoing example implementation, at least one radio transmission resource of the non-hopping set 52₁ of radio transmission resources can be utilized for a broadcast control channel (BCCH) (and/or for other standardized or common broadcast channels), while other radio transmission resources of the non-hopping set non-hopping set 52₁ of radio transmission resources can be utilized for calls comprising voice over internet protocol packet flows. For example, at least one timeslot of the non-hopping set 52₁ of radio transmission resources can be utilized for a BCCH (such as timeslots 56₁₋₁, for example), and other timeslots of the non-hopping set 52₁ of radio transmission resources (such as timeslots 56₁₋₂ through 56₁₋ⱼ, for example) can be utilized for the calls comprising voice over internet protocol packet flows.

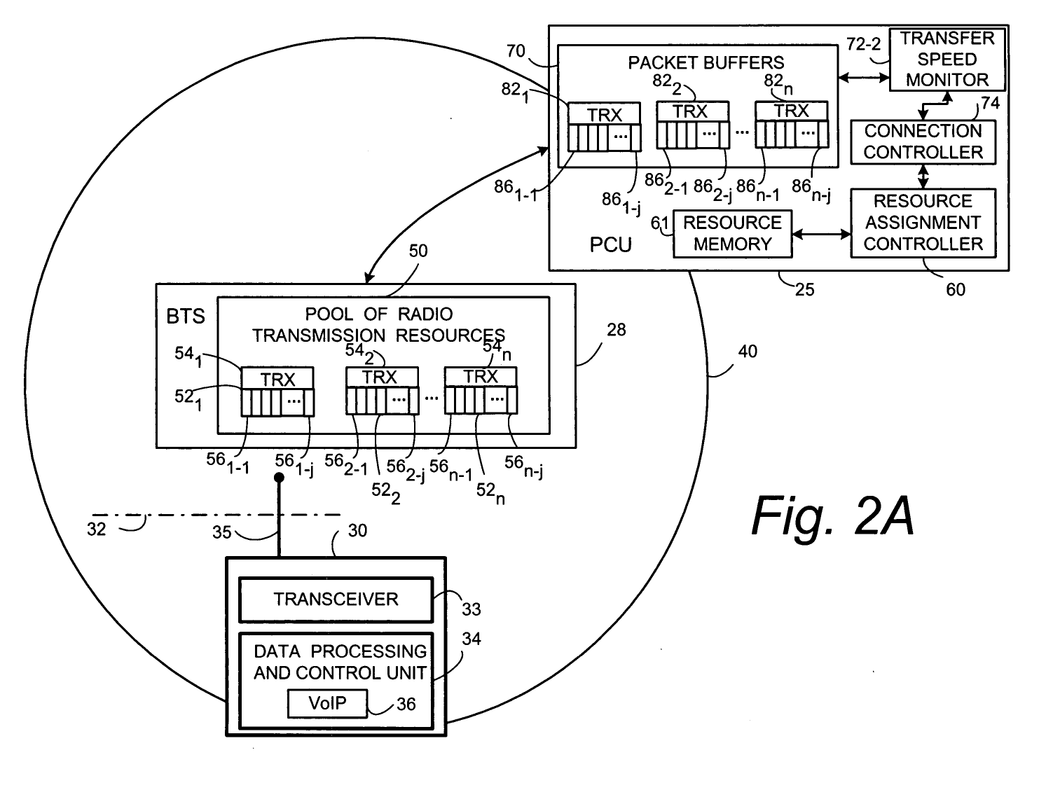

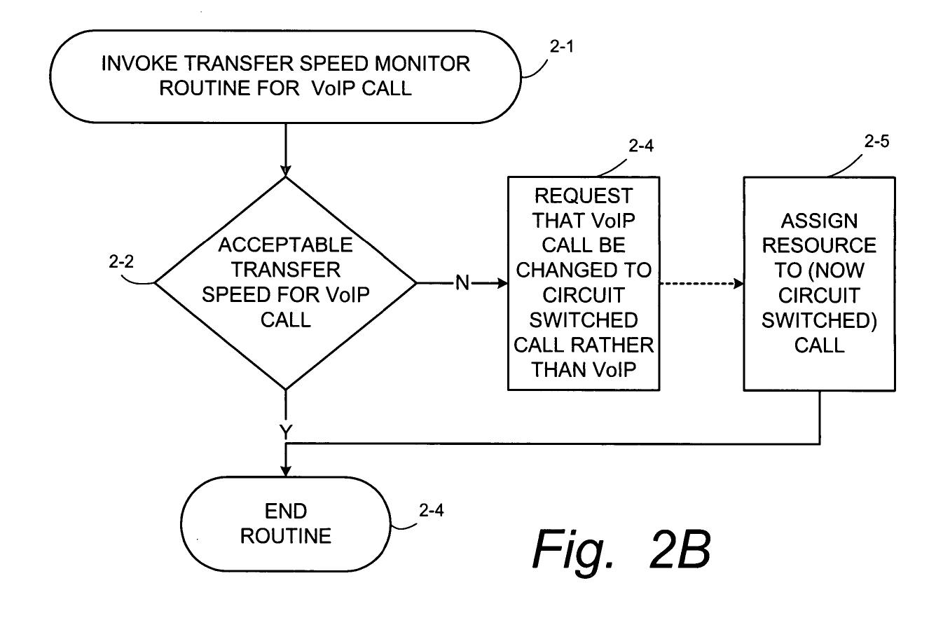

The packet control unit (PCU) 25 comprises resource assignment logic, which can be implemented (for example) by a resource assignment controller 60. In an example embodiment, resource assignment controller 60 schedules calls, the calls taking the form of voice over internet protocol packet flows in the method and/or manner of FIG. 2B. Thus, with its resource assignment controller 60, the packet control unit (PCU) 25 serves for allocating the radio transmission resources to respective voice over internet protocol (VoIP) calls handled as packet switched connections.

For its assignment and allocation of resources, resource assignment controller 60 may include a resource memory 61 or other mechanism for keeping track of allocation or assignment of resources of the sets 52 of radio transmission resources provided by base transceiver station (BTS) 28. The resource memory 61 may resemble a map or image of the sets 52 of radio transmission resources.

In addition, packet control unit (PCU) 25 is arranged and/or configured for determining, for at least one VoIP call handled by packet control unit (PCU) 25, whether the at least one VoIP call should be changed from a packet switched connection to a circuit switched connection. More specifically, in the example embodiment of FIG. 1, packet control unit (PCU) 25 determines whether the at least one VoIP call should be changed from a packet switched connection to a circuit switched connection by monitoring, in the telecommunications network, speech quality for the at least one VoIP call. In accordance with the monitoring, packet control unit (PCU) 25 is arranged for selectively requesting that the at least one VoIP call be changed from a first type of connection (e.g., a packet switched connection) to a second type of connection (e.g., a circuit switched connection).

Packet control unit (PCU) 25 comprises a buffer for the at least one call and is arranged for monitoring speech quality of the packets allocated to the at least one VoIP. Accordingly, in the illustrated, non-limiting example embodiment of FIG. 1, packet control unit (PCU) 25 further comprises a pool 70 of packet buffers; a speech quality monitor 72; and a connection controller 74.

The pool 70 of packet buffers can optionally be structured or conceptualized, if desired, as sets 82 of buffers, with each set corresponding to one of the set 52 of radio transmission resources provided by base transceiver station (BTS) 28. Thus, FIG. 1 shows n number of sets of buffers, e.g., set 82₁ through set 82ₙ. Each buffer set 82 comprises plural individual buffers 84, each buffer 84 being utilized for a separate call or packet flow. In the illustrated example implementation, there happens to be a separate buffer 86 for each timeslot of each transceiver 54, e.g., buffer 86₁₋₁ through buffer 86₁₋ⱼ corresponding to timeslot 56₁₋₁ through timeslot 56₁₋ⱼ of transceiver 54₁; buffer 86₂₋₁ through buffer 86₂₋ⱼ corresponding to timeslot 56₂₋₁ through timeslot 56₂₋ⱼ of transceiver 54₂; and so forth. In this example implementation, therefore, packets of the VoIP call occurring on timeslot 56₁₋₁ travel through buffer 84₁₋₁. It should be understood that, in other embodiments, the buffers 84 need not be grouped or associated in any particular manner, as long as a packet flow is associated with a buffer 84 through which its packets travel.

The buffers 84 of pool 70 of packet buffers can be realized or provided in various ways. Each buffer 84 can be a single memory element or device. Alternatively plural buffers 84 can be provided in a common memory element or device, e.g., semiconductor memory device or array, which is addressed, partitioned, or otherwise utilized to store or retrieve data with respect to the plural buffers 84.

In an example implementation shown in FIG. 2A, the speech quality monitor takes the form of a transfer speed monitor 72-2 which is configured as a buffer monitor for monitoring the transfer speed of packets in the buffer allocated to the at least one VoIP call, e.g., keeping track of buffer allocation and occupancy, including buffer fill or utilization level. For example, transfer speed monitor 72 (also known as buffer monitor 72) may have a head pointer and a tail pointer for pointing to memory locations which form respectively a head and a tail (or end) of data currently stored in the buffer. Using such pointers the transfer speed monitor 72-2 can track and/or store an amount or quantity of data in each buffer 84 at discrete points in time.

Connection controller 74 governs the particular connection through which a call is made. As such, connection controller 74 implements a connection type for the call, e.g., either circuit switched or packet switched. It is assumed, for a VoIP call, that (at least initially) a packet switched connection is set up by connection controller 74. After the packet switched connection of the VoIP call is set up, the packets forming the downlink packet flow of the VoIP call are routed through an appropriate one of the buffers 84 (the downlink buffer for the call) and packets forming the uplink packet flow of the VoIP call are routed through an appropriate one of the buffers 84 (the uplink buffer for the call).

In an example implementation of FIG. 2A, transfer speed monitor 72-2 of packet control unit (PCU) 25 can monitor the transfer speed of packets comprising the VoIP call by determining when a utilized amount of the buffer for the call exceeds a predetermined threshold. Alternatively, transfer speed monitor 72-2 of packet control unit (PCU) 25 monitors the transfer speed by determining when a variation of a utilized amount of the buffer exceeds a predetermined threshold.

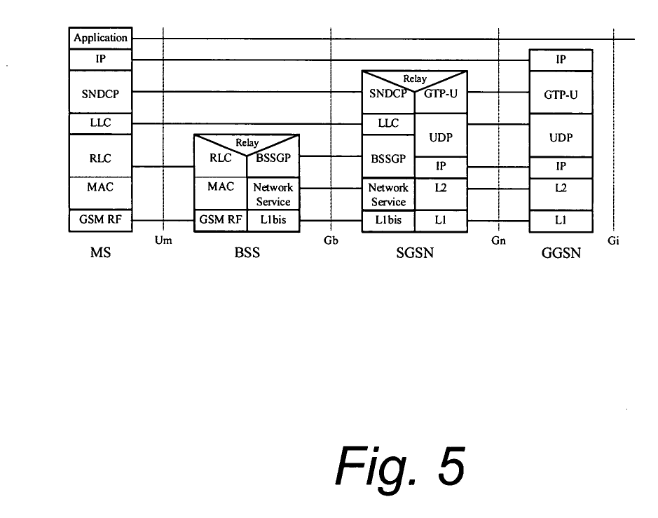

In the example implementation of FIG. 2A, the buffer which is monitored by transfer speed monitor 72-2 of packet control unit (PCU) 25 can be a logical link control layer (LLC) buffer, and the voice over internet protocol (VoIP) calls can be EDGE VoIP packet flows. As is well known in the art, and as illustrated in FIG. 5, LLC defines the logical link control layer protocol to be used for packet data transfer between the mobile station (MS) and a serving GPRS support node (SGSN). LLC spans from the mobile station to the SGSN and is intended for use with both acknowledged and unacknowledged data transfer. Alternatively or additionally, the buffer which is monitored by transfer speed monitor can be an radio link control (RLC) buffer.

FIG. 2B shows basic, example, representative, non-limiting steps or actions performed by packet control unit (PCU) 25 having the transfer speed monitor 72-2 of FIG. 2A in conjunction with the technology herein described. FIG. 2B primarily, but not necessarily exclusively, provides example steps for a transfer speed monitoring routine performed by transfer speed monitor 72-2 of packet control unit (PCU) 25. Step 2-1 illustrates the transfer speed monitoring routine (or an instance of the transfer speed monitoring routine) being invoked for a particular VoIP packet switched call. It should be understood that the transfer speed monitoring routine, or an instance thereof, can be invoked or begun separately for each VoIP packet switched call. Invocations of transfer speed monitoring routine can be prompted by a clock or some type of timeout, or some event or occurrence associated with a call. Thus, invocations of transfer speed monitoring routine can be periodic, e.g., at a set or adjustable frequency. Alternately, invocations of transfer speed monitoring routine can be aperiodic.

Upon its invocation, as step 2-2 the transfer speed monitoring routine checks whether an acceptable transfer speed exists for the VoIP packet switched call for which it was invoked. As such, buffer monitor 72-2 monitors the (e.g., LLC or RLC) buffer fullness in packet control unit (PCU) 25 specifically for VoIP flows.

As mentioned previously, in one example sub-mode of the first mode of operation, the transfer speed monitor 72-2 of packet control unit (PCU) 25 can monitor the transfer speed of packets comprising the VoIP call by determining when a utilized amount of the buffer for the call exceeds a predetermined threshold. Exceeding the predetermined threshold of the buffer tends to indicate that transfer speed has slowed since, e.g., the buffer is filling faster than it is emptying, thereby reflecting reduced transfer speed on the link(s) on the outgoing side.

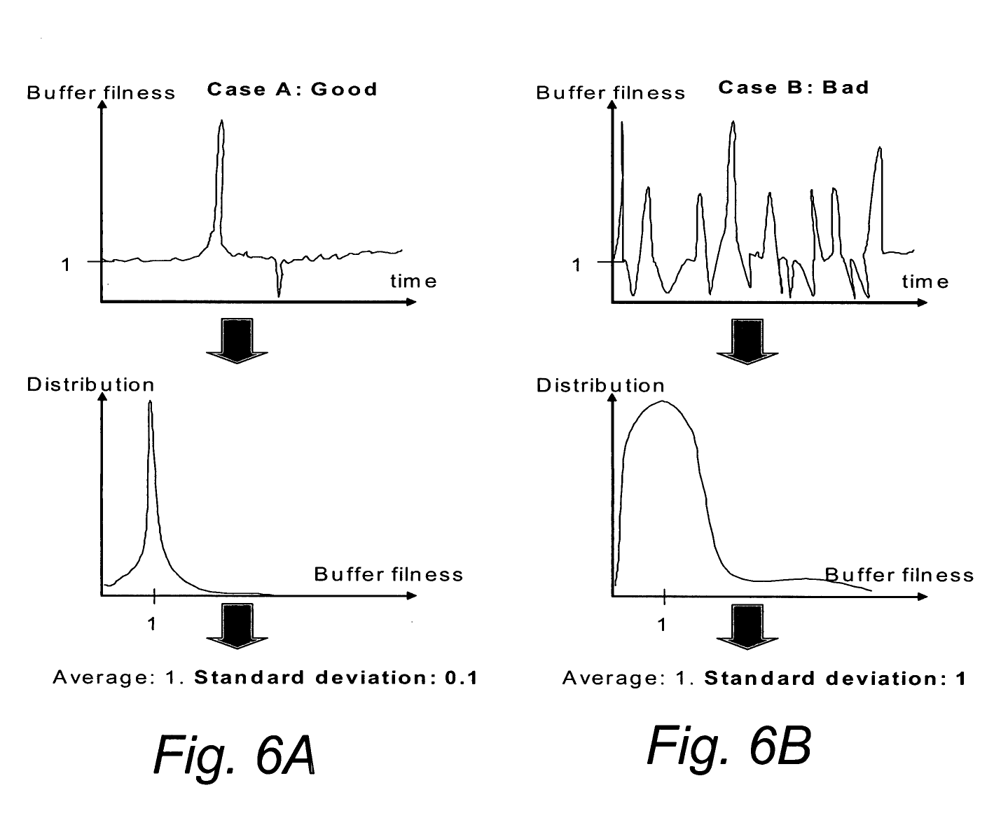

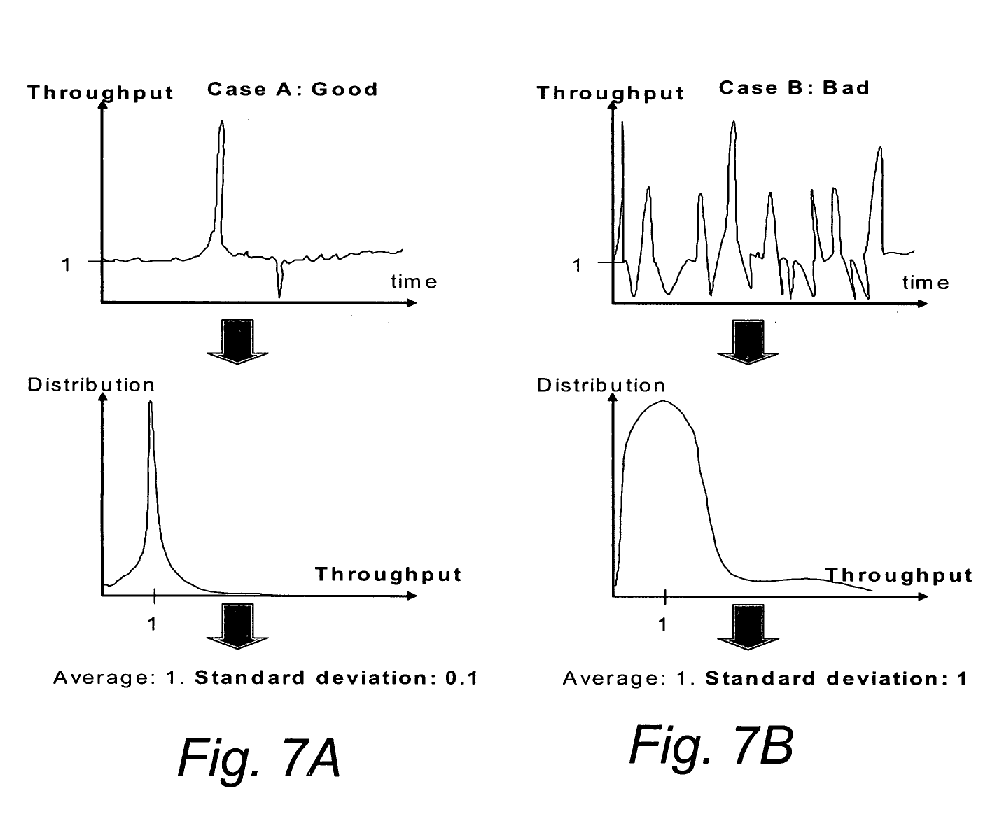

Alternatively, in another submode of the first mode of operation, the transfer speed monitor 72-2 of packet control unit (PCU) 25 can monitor the transfer speed by determining when a variation of a utilized amount of the buffer (buffer fillness) exceeds a predetermined (e.g. configured) threshold. In this regard, see FIG. 6A which show a good case of buffer fullness over time and thus an acceptable distribution of buffer fullness (standard deviation=0.1), in contrast to FIG. 6B which shows a bad case of buffer fullness over time with a poor distribution of buffer fullness (standard deviation=1). Similarly, FIG. 7A shows a good case of packet throughput (through the monitored buffer) over time and thus an acceptable distribution of throughput (standard deviation=0.1), in contrast to a bad case of FIG. 7B (standard deviation=1).

In either the two foregoing submodes or other comparable ways of operation, if it is determined at step 2-2 that the transfer speed for the VoIP call is acceptable, the transfer speed monitoring routine (or this instance thereof) can terminate as indicated by step 2-3. Otherwise, step 2-4 is performed.

Step 2-4 is performed when it is determined at step 2-2 that the transfer speed for the VoIP call is not acceptable, e.g., that the transfer speed is slow and therefore that poor speech quality or other low quality or problem occurs. As step 2-4 the transfer speed monitor 72 prompts packet control unit (PCU) 25 to request that the call be changed from one circuit connection type (e.g., a voice over internet protocol packet flow) to another circuit connection type (e.g., a circuit switched connection). Such request can be implemented, for example, by requesting that the mobile station (MS) 30 change the call from a voice over internet protocol packet flow to a circuit switched connection.

Assuming that, in response to the request of step 2-4, the call is switched to a circuit switch call rather than a VoIP call, eventually as step 2-5 the resource assignment controller 60 assigns another radio transmission resource to the (now circuit switched) call. The assigned radio transmission resource is configured or otherwise managed by connection controller 74 as a circuit switched connection. Assignment or reallocation of a call to a circuit switch call is understood by the person skilled in the art and is described, e.g., by section 6.3.6, among others, of 3GPP TS 23.806 V1.7.0 (2005-11), Technical Specification Group Service and System Aspects; Voice Call Continuity between CS and IMS Study (Release 7), incorporated herein by reference in its entirety.

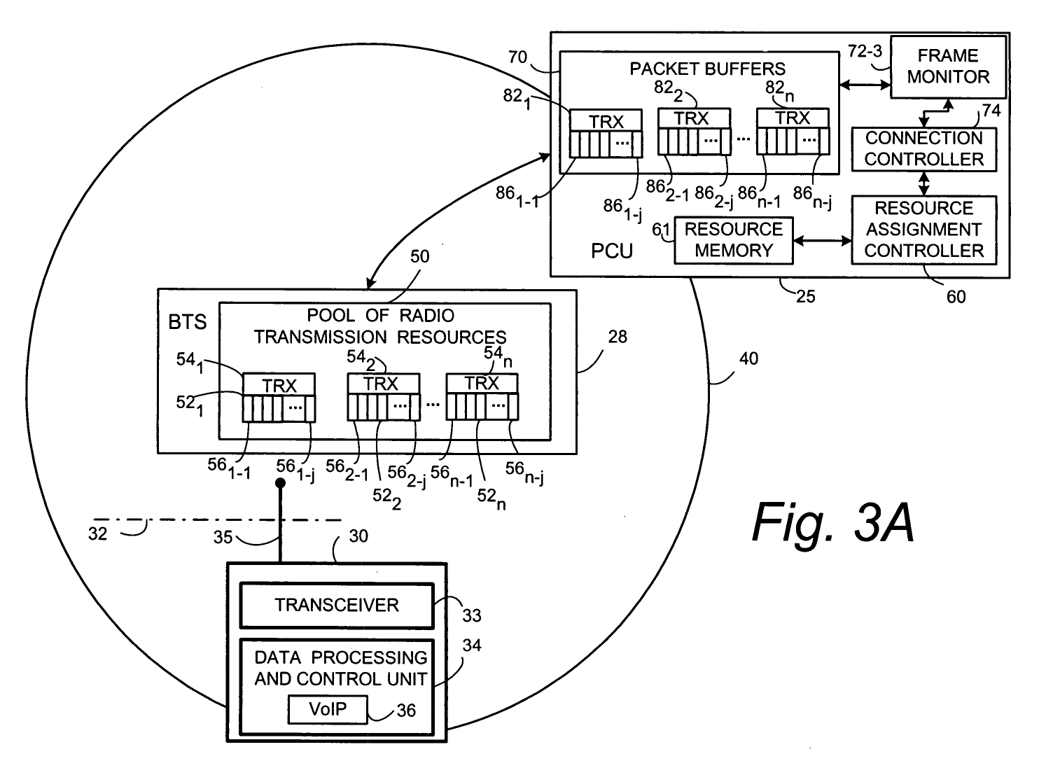

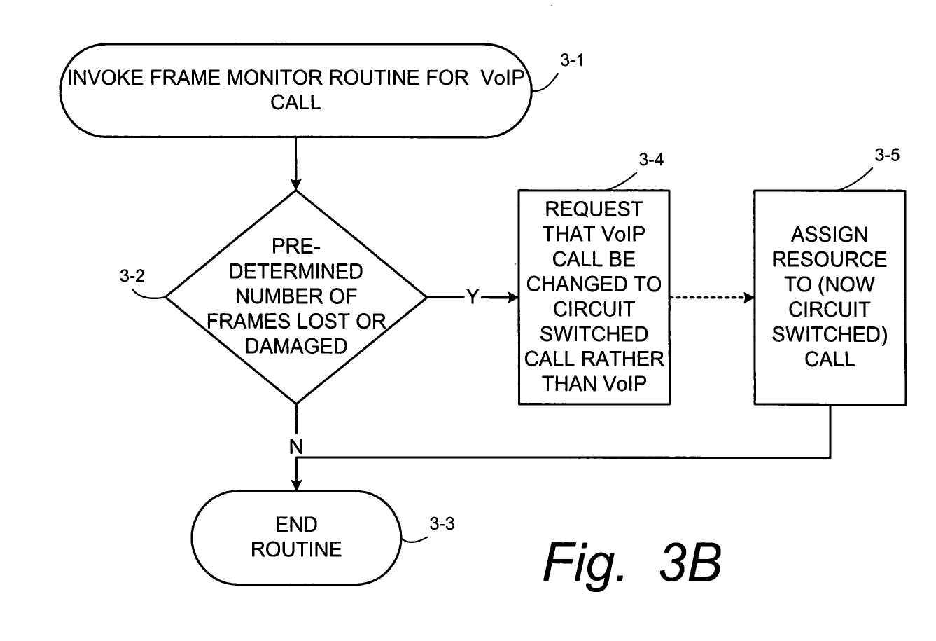

In an example implementation shown in FIG. 3A, the speech quality monitor takes the form of a frame monitor 72-3 which is configured as a buffer monitor for monitoring the presence and content (accuracy, integrity) of packets in the buffer allocated to the at least one VoIP call. For example, frame monitor 72-3 may work in conjunction with error detection/correction units/logic, and keeps track of a number of lost and/or damaged frames in the buffer for the monitored IP flow for the VoIP call. When frame monitor 72-3 of packet control unit (PCU) 25 determines that the number of lost of damaged frames exceeds a predetermined limit, the packet control unit (PCU) 25 requests that the at least one VoIP call be changed from a packet switched connection to a circuit switched connection.

In the example implementation of FIG. 3A, the buffer which is monitored by frame monitor 72-3 of packet control unit (PCU) 25 can be a logical link control layer (LLC) buffer or a radio link control (RLC) buffer, and the voice over internet protocol (VoIP) calls can be EDGE VoIP packet flows.

FIG. 3B shows basic, example, representative, non-limiting steps or actions performed by packet control unit (PCU) 25 having the frame monitor 72-3 in conjunction with the technology herein described. FIG. 3B primarily, but not necessarily exclusively, provides example steps for a frame presence/quality monitoring routine (“frame monitoring routine”) performed by frame monitor 72-2 of packet control unit (PCU) 25. Step 3-1 illustrates the frame monitoring routine (or an instance of the frame monitoring routine) being invoked for a particular VoIP packet switched call. It should be understood that the frame monitoring routine, or an instance thereof, can be invoked or begun separately for each VoIP packet switched call. Invocations of the frame monitoring routine can be prompted by a clock or some type of timeout, or some event or occurrence associated with a call. Thus, invocations of frame monitoring routine can be periodic, e.g., at a set or adjustable frequency. Alternately, invocations of frame monitoring routine can be aperiodic.

Upon its invocation, as step 3-2 the frame monitoring routine checks whether the number of detected losses or damaged frames thus far noted for the VoIP packet flow (associated with the buffer which it monitors) exceeds a predetermined limit. If not, the frame monitoring routine (or this instance thereof) can terminate as indicated by step 3-3. Otherwise, step 3-4 is performed.

Step 3-4 is performed when it is determined at step 3-2 that the number of detected losses or damaged frames thus far noted for the VoIP packet flow monitored by frame monitor 72-3 exceeds a predetermined limit. Exceeding the predetermined limit is a measure or indication of poor speech quality or other low quality or problem. As step 3-4 the frame monitor 72-3 prompts packet control unit (PCU) 25 to request that the call be changed from one circuit connection type (e.g., a voice over internet protocol packet flow) to another circuit connection type (e.g., a circuit switched connection). Such request can be implemented, for example, by requesting that the mobile station (MS) 30 change the call from a voice over internet protocol packet flow to a circuit switched connection.

Assuming that, in response to the request of step 3-4, the call is switched to a circuit switch call rather than a VoIP call, eventually as step 3-5 the resource assignment controller 60 assigns another radio transmission resource to the (now circuit switched) call. The assigned radio transmission resource is configured or otherwise managed by connection controller 74 as a circuit switched connection. Requesting that the at least one VoIP call be changed from a packet switched connection to a circuit switched connection can comprises requesting a mobile station participating in the call to perform a packet-switch to circuit-switch handover and thereby reattach the call as a circuit switch call. For example, a message is sent from the packet control unit (PCU) 25 to the mobile station (MS) 30 in the form of a “PS-to-CS HO Command”. The mobile station (MS) 30 will perform a PS-to-CS handover and re-attach the call as a circuit switch call on another resources (e.g., on a hopping resource [e.g., a hopping transceiver] or on a non-hopping resource [e.g., a non-hopping transceiver]).

In the non-limiting illustration of FIG. 1, a radio transmission resource takes the form of a timeslot on a frequency/frequencies provided by a transceiver, with the set of timeslots provided by the transceiver being referred to as a set of resources. It should be appreciated, however, that the above technique (e.g., of changing a call to a circuit switched call when transmission quality or transfer speed requires) can be implemented when the radio transmission resources take forms other than timeslots. In this regard, a “radio transmission resource” as utilized herein can take other forms such as (for example) a channel, radio bearer, or subdivision or aspect of a carrier allocated to a call, even in technologies which do not utilize timeslots (such as WCDMA, HSDPA, WiMAX, and CDMA 2000, for example).

The packet control unit (PCU) 25, for the foregoing and other embodiments encompassed hereby, can be located either entirely or partially at any suitable network node, such as at a base station control (BSC) node 26 as shown in FIG. 1A, a base transceiver station (BTS) or base station node as shown in FIG. 1B, or a GPRS Support node (GSN) 27 as shown in FIG. 1C. By located partially at a node means that the functionality of packet control unit (PCU) 25 can be distributed over two or more nodes.

In an example implementation, the calls comprising voice over internet protocol (VoIP) packet flows are EDGE (Enhanced Data Rates for Global Evolution) VoIP flows. As utilized herein, “EDGE” includes EDGE Evolution, also known, e.g., as EDGE Phase 2. FIG. 5 is a protocol diagram of an EDGE system. In EGPRS, packet control unit (PCU) 25 relays the LLC frames (depicted as “Relay” on BSS in FIG. 5) between the mobile station (MS) 30 and the core network.

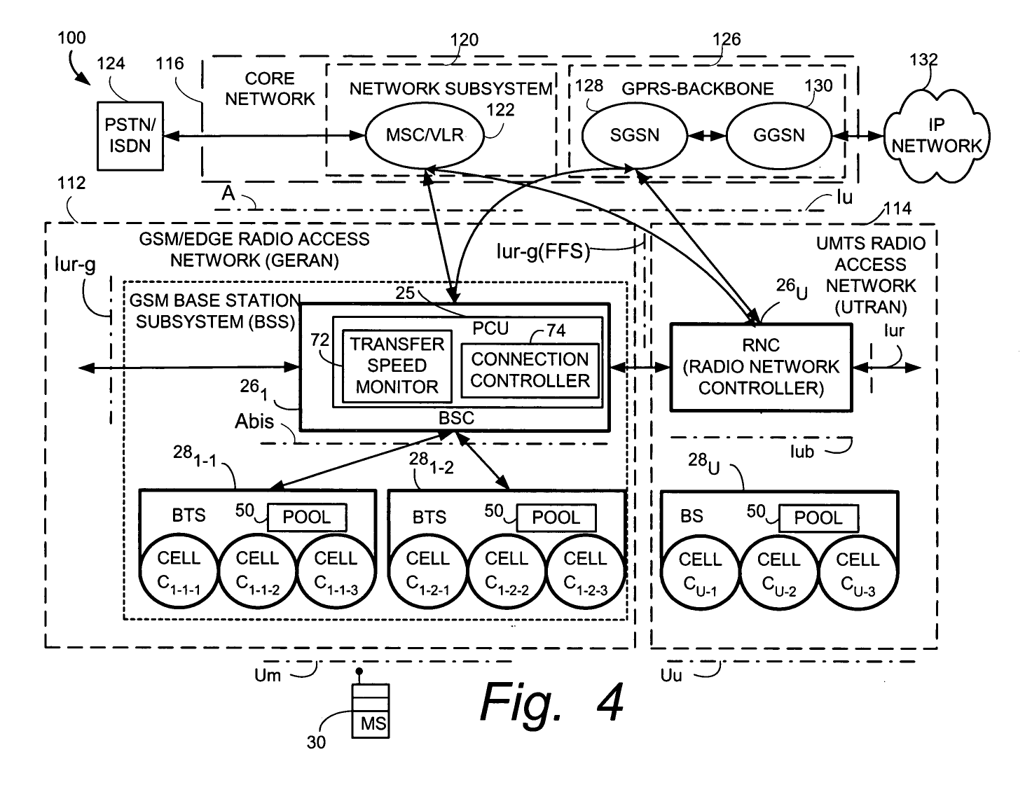

FIG. 4 shows a telecommunications system 100 which provides an example, illustrative context in which the foregoing structure may be found and the foregoing methods may be practiced. The example telecommunications system 100 of FIG. 4 operates in conjunction with both a first radio access network 112 having a first type radio access technology and a second radio access network 114 having a second type radio access technology. In the non-limiting example shown in FIG. 4, the first radio access network 112 uses GSM/EDGE radio access technology (GERAN), while the second radio access network 114 uses UTRAN radio access technology.

Both first radio access network 112 and second radio access network 114 are connected to an external core network(s) 116. The core network(s) 116 include a network subsystem 120 for circuit switched connections, featuring a Mobile Switching Center (MSC) 122 which typically operates in conjunction with registers such as a visitor location register (VLR). The network subsystem 120 is typically connected to (for example) the Public Switched Telephone Network (PSTN) 124 and/or the Integrated Services Digital Network (ISDN).

The core network(s) 116 also include a GPRS/backbone 126 which comprises a serving GPRS service node (SGSN) 128 and a Gateway GPRS support node (GGSN) node 130. The GPRS/backbone 126 is connected to connectionless-oriented external network such as IP Network 132 (e.g., the Internet). Thus, the packet switched connections involve communicating with Serving GPRS Support Node (SGSN) 128 which in turn is connected through a backbone network and Gateway GPRS support node (GGSN) 130 to packet-switched networks 130 (e.g., the Internet, X.25 external networks).

The core network(s) 116 can connect to the first radio access network 12 (e.g., the GERAN) over either an interface known as the A interface, an interface known as the Gb interface, or an open Iu interface, or any combination of these three interfaces. In FIG. 4, it is assumed that the first radio access network is only connected over the Iu interface. The first radio access network 112 includes one or more base station controllers (BSCs) 26, with each base station controller (BSC) 26 controlling one or more base transceiver stations (BTSs) 28. In the example shown in FIG. 4, base station controller (BSC) 26₁ is connected across the Abis interface to two base transceiver stations, particularly base transceiver station (BTS) 28₁₋₁ and base transceiver station (BTS) 28₁₋₂. Each base transceiver station (BTS) 28₁ is depicted in FIG. 4 as serving three cells C. Each cell C is represented by a circle proximate the respective base station. Thus, it will be appreciated by those skilled in the art that a base station may serve for communicating across the air interface for more than one cell, and that differing base stations may serve differing numbers of cells.

FIG. 4 also shows that the GERAN typically comprises plural base station controllers (BSCs) 26, although only one of such base station controllers, particularly base station controller (BSC) 26₁, is illustrated. For simplicity, details of the base station subsystem (BSS) involving base station controller (BSC) 26₂ are omitted. The base station controllers 26 control radio resources and radio connectivity within a set of cells. Each base station (BTS) 28 handles the radio transmission and reception within one or more cells.

The core network 116 also connects to the second radio access network 114 (e.g., the UTRAN radio access network) over an interface know as the Iu interface. The second radio access network 114 includes one or more radio network controllers (RNCs) 26_{U}. For sake of simplicity, the UTRAN 114 of FIG. 1 is shown with only one RNC node. The RNC node 26_{U} is connected to a plurality of base stations 28_{U} (e.g., node Bs). In second radio access network (UTRAN network) 114, the radio network controller (RNC) 26_{U} controls radio resources and radio connectivity within a set of cells, while the base stations handle the radio transmission and reception within one or more cells. The Abis interface, a radio interface Um, the Iu interface, and the other interfaces are shown by dash-dotted lines in FIG. 4.

In the particular non-limiting example described in FIG. 4, the packet control unit (PCU) 25 is situated at the base station controller (BSC) 26 essentially in the manner depicted in FIG. 1A. It will be recalled that packet control unit (PCU) 25 could be located elsewhere, as illustrated by FIG. 1B and FIG. 1C, for example. In accordance with the technique described herein, a monitored buffer of the base station controller (BSC) 26 (such as the LLC buffer or the RLC buffer) is monitored for VoIP media flows. Should the example of FIG. 4 operate in accordance with the embodiment of FIG. 2A and FIG. 2B, when the monitored buffer meets certain variation or threshold parameters, the network signals a PS-to-CS handover command to the MS, which then changes from VoIP to a traditional (and maybe safer) circuit switched connection. On the other hand, should the example of FIG. 4 operate in accordance with the embodiment of FIG. 3A and FIG. 3B, when the number of damaged or lost frames observed in the monitored buffer exceeds a predetermined number, the network signals a PS-to-CS handover command to the MS, which then changes from VoIP to a traditional (and maybe safer) circuit switched connection.

The foregoing assumes that packet control unit (PCU) 25 can detect a VoIP flow. The person skilled in the art knows how VoIP flow can be detected, e.g., by examining a set of quality of service (QoS) attributes such as (for example) the QoS Conversational bit set by the mobile station in the setup of the VoIP data flow, or by checking for any other type of VoIP signature configured in or appended to the VoIP data flow. Yet other techniques are disclosed in U.S. Provisional Patent Application 60/684,233 entitled “Authenticated Identification of VoIP Flow in BSS,” filed on May 25, 2005, which is incorporated herein by reference in its entirety.

As explained above, step 2-2 and step 3-2 include sending a message from base station controller (BSC) 26 to mobile station (MS) 30 in the form, e.g., of a “PS-to-CS Handover Command”. Such message commands mobile station (MS) 30 to make a packet switched (PS)-to-circuit switched (CS) handover, moving away from the VoIP domain and over/into the traditional CS domain.

Especially in the early phases of VoIP introduction, a number of issues are anticipated since so many components are new. Using the “safe-guard” techniques provided herein, at any issue with the packet switched delivery, no matter the cause, the packet control unit (PCU) 25 will detect the problem condition. Such detection is due, at least in part, in that the number of LLC frames waiting to be sent from the packet control unit (PCU) 25 will be filling up if there is no delivery to the mobile station (MS) 30. Upon such detection of a predetermined amount of waiting frames, the mobile station (MS) 30 will be commanded to handover to the circuit switched domain, where mobile station (MS) 30 is likely to be able to continue the call.

The foregoing technique may facilitate an earlier than otherwise anticipated introduction of voice over internet protocol (VoIP) services.

Buffer (LLC or RLC) level and variation detection as performed in and by packet control unit (PCU) 25 thus enable a commanding of the mobile station (MS) 30 away from the VoIP domain and over/into to the traditional circuit switched domain at any issue that may arise with packet switched delivery. As discussed above, another criteria for discerning poor speech quality (and responsively triggering a packet switch to circuit switch handover for the VoIP flow suffering the poor speech quality) involves monitoring for lost or damaged frames in the VoIP flow.

Although various embodiments have been shown and described in detail, the claims are not limited to any particular embodiment or example. None of the above description should be read as implying that any particular element, step, range, or function is essential such that it must be included in the claims scope. The scope of patented subject matter is defined only by the claims. The extent of legal protection is defined by the words recited in the allowed claims and their equivalents. It is to be understood that the invention is not to be limited to the disclosed embodiment, but on the contrary, is intended to cover various modifications and equivalent arrangements.

What is claimed is:

1. A method of operating a telecommunications network comprising:
allocating radio transmission resources of a cell to respective voice over internet protocol (VoIP) calls handled as packet switched connections;
monitoring quality for at least one VoIP call;
in accordance with the monitoring, requesting that the at least one VoIP call be changed from a packet switched connection to a circuit switched connection.

2. The method of claim 1, wherein the step of monitoring quality for the at least one VoIP call comprises monitoring in the telecommunications network a transfer speed of packets comprising the at least one VoIP call.

3. The method of claim 2, wherein the step of monitoring quality further comprises monitoring a transfer speed in a buffer of the packets comprising the at least one VoIP.

4. The method of claim 3, wherein the monitoring comprises determining when a utilized amount of the buffer exceeds a predetermined threshold.

5. The method of claim 3, wherein the monitoring comprises determining when a variation of a utilized amount of the buffer exceeds a predetermined threshold.

6. The method of claim 3, wherein the buffer is a logical link control layer (LLC) buffer.

7. The method of claim 3, wherein the buffer is a radio link control (RLC) buffer of a base station controller node.

8. The method of claim 3, wherein the buffer is a buffer of a packet control unit.

9. The method of claim 1, wherein the step of requesting that the at least one VoIP call be changed from a packet switched connection to a circuit switched connection comprises requesting a mobile station participating in the call to perform a packet-switch to circuit-switch handover and thereby reattach the call as a circuit switch call.

10. The method of claim 1, wherein the voice over internet protocol (VoIP) calls are EDGE VoIP packet flows.

11. The method of claim 1, wherein the step of monitoring quality comprises monitoring for a predetermined number of lost or damaged frames of the at least one VoIP call.

12. A method of operating a telecommunications network comprising:
allocating radio transmission resources of a cell to respective voice over internet protocol (VoIP) calls handled as packet switched connections;
for at least one VoIP call, monitoring a utilization level of a buffer of packets comprising the at least one VoIP call;
in accordance with the monitoring, selectively requesting that the at least one VoIP call be changed from a packet switched connection to a circuit switched connection.

13. The method of claim 12, wherein the monitoring of the utilization level comprises determining when a utilized amount of the buffer exceeds a predetermined threshold.

14. The method of claim 12, wherein the monitoring of the utilization level comprises determining when a variation of a utilized amount of the buffer exceeds a predetermined threshold.

15. The method of claim 12, wherein the buffer is a logical link control layer (LLC) buffer.

16. The method of claim 12, wherein the buffer is a radio link control (RLC) buffer.

17. The method of claim 12, wherein the buffer is a buffer of a packet control unit.

18. The method of claim 12, wherein the step of requesting that the at least one VoIP call be changed from a packet switched connection to a circuit switched connection comprises requesting a mobile station participating in the call to perform a packet-switch to circuit-switch handover and thereby reattach the call as a circuit switch call.

19. The method of claim 12, wherein the voice over internet protocol (VoIP) calls are EDGE VoIP packet flows.

20. A telecommunications network comprising:
a base transceiver station node for providing radio transmission resources to a cell for radio frequency communications;
a packet control unit for allocating the radio transmission resources to respective voice over internet protocol (VoIP) calls handled as packet switched connections and which, for at least one VoIP call, is arranged
for monitoring in the telecommunications network of the at least one VoIP call and, in accordance with the monitoring,
for selectively requesting that the at least one VoIP call be changed from a packet switched connection to a circuit switched connection.

21. The apparatus of claim 20, wherein the packet control unit comprises a buffer, and wherein for monitoring the speech quality the packet control unit is arranged for monitoring a number of lost or damaged frames in the VoIP packet flow for the at least one VoIP call.

22. The apparatus of claim 20, wherein the packet control unit comprises a buffer, and wherein for monitoring the speech quality the packet control unit is arranged for monitoring a transfer speed in the buffer of the packets comprising the at least one VoIP.

23. The apparatus of claim 22, wherein the packet control unit is arranged for determining when a utilized amount of the buffer exceeds a predetermined threshold.

24. The apparatus of claim 22, wherein the packet control unit is arranged for determining when a variation of a utilized amount of the buffer exceeds a predetermined threshold.

25. The apparatus of claim 22, wherein the buffer is a logical link control layer (LLC) buffer.

26. The apparatus of claim 22, wherein the buffer is a radio link control (RLC) buffer.

27. The apparatus of claim 20, wherein the voice over internet protocol (VoIP) calls are EDGE VoIP packet flows.

28. The apparatus of claim 20, wherein the packet control unit is at least partially situated at a base station controller node.

29. The apparatus of claim 20, wherein the packet control unit is at least partially situated at a base station node.

30. The apparatus of claim 20, wherein the packet control unit is at least partially situated at a GPRS Support Node.

31. A telecommunications network comprising:
a base transceiver station node for providing radio transmission resources to a cell for radio frequency communications;
a packet control unit for allocating the radio transmission resources to respective voice over internet protocol (VoIP) calls handled as packet switched connections and which, for at least one VoIP call, is arranged
for monitoring a utilization level of a buffer of packets comprising the at least one VoIP call and, in accordance with the monitoring,
for selectively requesting that the at least one VoIP call be changed from a packet switched connection to a circuit switched connection.

32. The apparatus of claim 31, wherein the packet control unit is arranged for determining when a utilized amount of the buffer exceeds a predetermined threshold.

33. The apparatus of claim 31, wherein the packet control unit is arranged for determining when a variation of a utilized amount of the buffer exceeds a predetermined threshold.

34. The apparatus of claim 31, wherein the buffer is a logical link control layer (LLC) buffer.

35. The apparatus of claim 31, wherein the buffer is a radio link control (RLC) buffer.

36. The apparatus of claim 31, wherein the voice over internet protocol (VoIP) calls are EDGE VoIP packet flows.

37. The apparatus of claim 31, wherein the packet control unit is at least partially situated at a base station controller node.

38. The apparatus of claim 31, wherein the packet control unit is at least partially situated at a base station node.

39. The apparatus of claim 31, wherein the packet control unit is at least partially situated at a GPRS Support Node.
